(19) United States
(12) Patent Application Publication
(10) Pub. No.: US 2017/0035018 A1
(43) Pub. Date: Feb. 9, 2017

(54) DAIRY INFLATION AND METHOD OF MAKING SAME

(71) Applicant: P.E.T. Polymer Extrusion Technology, Inc., Pompano Beach, FL (US)

(72) Inventors: Stephen E. Howes, Davie, FL (US); Gerhard Reichart, New Philadelphia, OH (US)

(21) Appl. No.: 15/303,956

(22) PCT Filed: Apr. 10, 2015
(86) PCT No.: PCT/US15/25236

§ 371 Date: Oct. 13, 2016

Related U.S. Application Data
(60) Provisional application No. 61/980,184, filed on Apr. 16, 2014.

(51) Int. Cl. A01J 5/04; B29B 13/02; B29C 39/38; C08G 18/32; B29C 39/02

(52) U.S. Cl. CPC A01J 5/04; C08G 18/3206; B29C 39/02; B29C 39/38; B29B 13/02; B29K 2075/00

(57) ABSTRACT

A dairy inflation (10) for use in a milking device, including a flexible sleeve (24) adapted to surround a teat, wherein the flexible sleeve (24) includes a clear polyurethane composition. The clear polyurethane composition can be derived from a polyol mixture including a glycerine-based polyol having an average molecular weight in a range from about 200 g/mol to about 300 g/mol, and a first hydroxyl value; and a glycol-based polyol having an average molecular weight in a range from about 600 g/mol to about 700 g/mol, and a second hydroxyl value; and about 0.65 to about 1.05 stoichiometric equivalents of a cross-linking agent comprising a plurality of isocyanate groups, wherein the stoichiometric equivalents is based on a sum of the first and second hydroxyl values.

### FIELD OF THE INVENTION

The present invention relates generally to dairy inflations for extracting milk from an animal.

### BACKGROUND OF THE INVENTION

Vacuum-based milking systems that utilize dairy inflations have been used extensively in dairy operations worldwide. The principle of vacuum-based milking is to extract milk from a teat by 1) application of a substantially constant partial vacuum to the end of the teat and convey the extracted milk to a suitable container, and 2) to give a periodic squeeze applied externally to the teat to maintain blood circulation therein. Conventional vacuum-based milking systems include a relatively hard or rigid outer shell within which is mounted a flexible, resilient dairy inflation. Such dairy inflations are also commonly referred to as liners or teat cups. Fluctuating, or pulsating, pressures are applied to an annulus between the shell and the outer surface of the dairy inflation to massage an animal's teat, which is held by the dairy inflation. The massaging of the teat further facilitates the ejection of milk, which is then vacuum drawn through tubing to a centralized collecting vessel.

Traditional dairy inflations are made by injection molding one or more elastomers, such as natural, nitrile, or silicone rubber compounds. However, the composition of the dairy inflations affects their useful working life, measured in “individual cow milkings” or ICMs, because the physical shape, tension, and surface condition gradually deteriorates with the dairy inflation use, age, and storage. This gradual deterioration can have subtle but significant effects on their milking characteristics, which thereby shortens the number of useful ICMs of the inflation.

For example, natural rubber dairy inflations, while having excellent cut resistance and dynamics, are susceptible to oil swell and oxidation. Dairy inflations made of natural rubber have been reported to have a working life of about 600-800 ICMs. Nitrile rubber dairy inflations, while having superior resistance to oil swell, have poorer dynamics and cut resistance relative to other polymers. Accordingly, nitrile rubber is quite often blended with other rubbers, such as natural rubber or styrene-butadiene rubber, and can achieve 900 to 2,500 ICMs depending on the ratios of natural, nitrile and styrene butadiene rubbers. Silicone rubber dairy inflations, which are substantially more expensive than their natural or nitrile rubber counterparts, have been reported to have a working life from about 3,000 ICMs up to about 8,000 ICMs, presumably depending on the type of silicone used.

However, the traditional natural, nitrile, or silicone rubber-based dairy inflations typically require compounding with fillers, such as carbon black and/or silica to achieve the requisite physical properties of a useful dairy inflation. One consequence of the presence of these fillers is the lack of transparency of the dairy inflation, which prevents an operator of the milking system to visually determine if the teat is properly positioned in the dairy inflation, if the milk extraction process is proceeding satisfactorily or completed, or if the milk extraction has blood or pus in it. Another consequence of using fillers is the potential shedding of fillers like carbon black into the milk as the inflation ages, which can cause health issues to humans and dairy animals alike.

A need therefore exists for a dairy inflation compound that overcomes the disadvantages associated with natural, nitrile, and silicone dairy inflations.

### SUMMARY OF THE INVENTION

Embodiments of the present invention relate to a vacuum-based milking system for animals. More particularly, embodiments of the present invention relate to a dairy inflation for use in a vacuum-based milking device.

In accordance with an embodiment of the present invention, a dairy inflation for use in a vacuum-based milking device is provided. The dairy inflation comprises a mouth having an opening configured to engage a teat of an animal, a flexible sleeve connected to the mouth and including an axial passage concentrically aligned with the opening in the mouth; and a milk tube connected to the flexible sleeve and having an axial passage concentrically aligned with the axial passage of the flexible sleeve, wherein the mouth, the flexible sleeve, and the milk tube are formed of a clear polyurethane composition having a hardness between 25 shore A and 50 shore D at 77° F. (25° C.).

In accordance with another embodiment, a method of making a dairy inflation for use in a vacuum-based milking device is provided. The method comprises combining about 20 wt % to about 50 wt % of a glycerine-based polyol having an average molecular weight in a range from about 200 g/mol to about 300 g/mol, and a first hydroxyl value; about 20 wt % to about 70 wt % of a glycol-based polyol having an average molecular weight in a range from about 600 g/mol to about 700 g/mol, and a second hydroxyl value; about 0.90 to about 1.00 stoichiometric equivalents of a diisocyanate compound, wherein the stoichiometric equivalents of the isocyanate functional group is based on a sum of the first and second hydroxyl values; and about 0 wt % to about 30 wt % of a plasticizer to form a polyurethane premixture; filling a dairy inflation mold with the polyurethane premixture; and heating the filled dairy inflation mold to a temperature in a range from about 200° F. to about 400° F. to form the dairy inflation comprising a clear polyurethane composition.

### BRIEF DESCRIPTION OF THE DRAWINGS

The accompanying drawings, which are incorporated in and constitute part of the specification, illustrate embodiments of the invention and, together with the general description of the invention given above, and the detailed description of embodiments given below, serve to explain the principles of the invention.

FIG. 1 illustrates a longitudinal cross-sectional view of a dairy inflation, in accordance with an embodiment of the present invention;

FIG. 2 illustrates a longitudinal cross-sectional view of a dairy inflation assembled with the shell member of FIG. 3, in accordance with an embodiment of the present invention

FIG. 3 illustrates a longitudinal cross-sectional view of a shell member, in accordance with an embodiment of the present invention; and

FIG. 4 illustrates a perspective view of the dairy inflation of FIG. 1 inserted within the shell member of FIG. 3.

### DETAILED DESCRIPTION

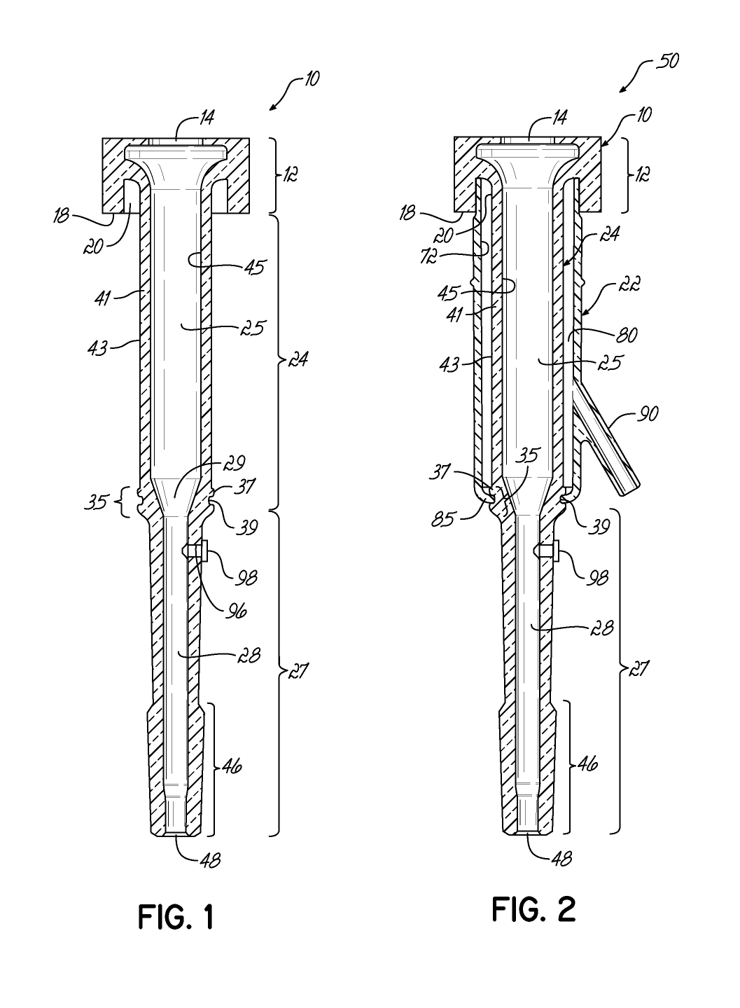

Referring to FIG. 1, a dairy inflation 10 according to an embodiment of the present invention is provided for extracting milk from an animal, such as a cow or goat. The dairy inflation 10 includes a mouth portion 12 having an opening 14 configured to engage a teat of the animal. The mouth portion 12 includes a lip 18 extending away from the opening 14 to create a recess 20, which accepts an upper end portion of a shell member 22 (described below). A flexible sleeve 24 may be integrally connected to the mouth portion 12, the flexible sleeve 24 having an axial passage 25 fluidly connected to the opening 14 of the mouth portion 12. A milk tube portion 27 may be integrally connected to the flexible sleeve 24, the milk tube portion 27 having an axial passage 28 fluidly connected to the axial passage 25 of the flexible sleeve 24. Preferably, though not necessarily, the opening 14 of the mouth portion 12, the axial passage 25 of the flexible sleeve 24, and the axial passage 28 of the milk tube portion 27 are coaxial.

In one embodiment, the diameter of the axial passage 28 of the flexible sleeve may be less than the diameter of the axial passage 25 of the milk tube. In this embodiment, the flexible sleeve 24 may include a transition region 29 at an end of the flexible sleeve 24 opposite the mouth portion 12. The axial passage 25 passing through the transition region 29 tapers down to a smaller diameter that preferably equals the diameter of the axial passage 28 of the milk tube portion 27. Although not shown, the flexible sleeve 24 may be formed as cylindrical tube, a rectangular tube, or other polygon tube. A resting state diameter of the axial passage 28 may be constant from the mouth portion 12 to the milk tube portion 27, or the diameter may be varied.

A reinforcement ring 35 may be circumferentially positioned around an outer surface of the flexible sleeve 24 at the transition region 29. As will be discussed in more detail below, the reinforcement ring 35 provides additional material in the transition region 29 to minimize the risk of the dairy inflation 10 tearing in this particular region due to the radial slot or recess for mounting of the shell member 22. In one embodiment, the reinforcement ring 35 may include an umbrella 37 that extends radially outward from the flexible sleeve 24 to form a recess 39 beneath the umbrella 37.

Referring still to FIG. 1, the axial passages 25, 28 are defined by a wall 41 having an exterior surface 43 and an interior surface 45. As described in more detail below, the dairy inflation 10 is made from a clear polyurethane composition. The dairy inflation 10 may be formed using a multi-piece mold such as a two- or three-piece mold using an open mold technique, which provides a uniform density throughout the thickness of the wall 41. In other words, the open mold technique, which is not a high pressure injection method, provides a homogeneous, clear polyurethane wall having similar density and properties from the exterior surface 43 through the cross-section of the wall 41 to the interior surface 45.

The milk tube portion 27 may include a thickened wall portion 46 or one or more reinforcement rings (not shown) positioned around an exterior surface of the milk tube portion 27. The milk tube portion 27 includes an opening 48 that is configured to be attached to a claw of a milk collection apparatus (not shown). The claw provides a male fitting that is inserted into the axial passage 28 of the milk tube portion 27. The thickened wall portion 46 prevents tearing or other damage to the milk tube portion 27 that could be caused by the claw during insertion, removal, and/or during operation.

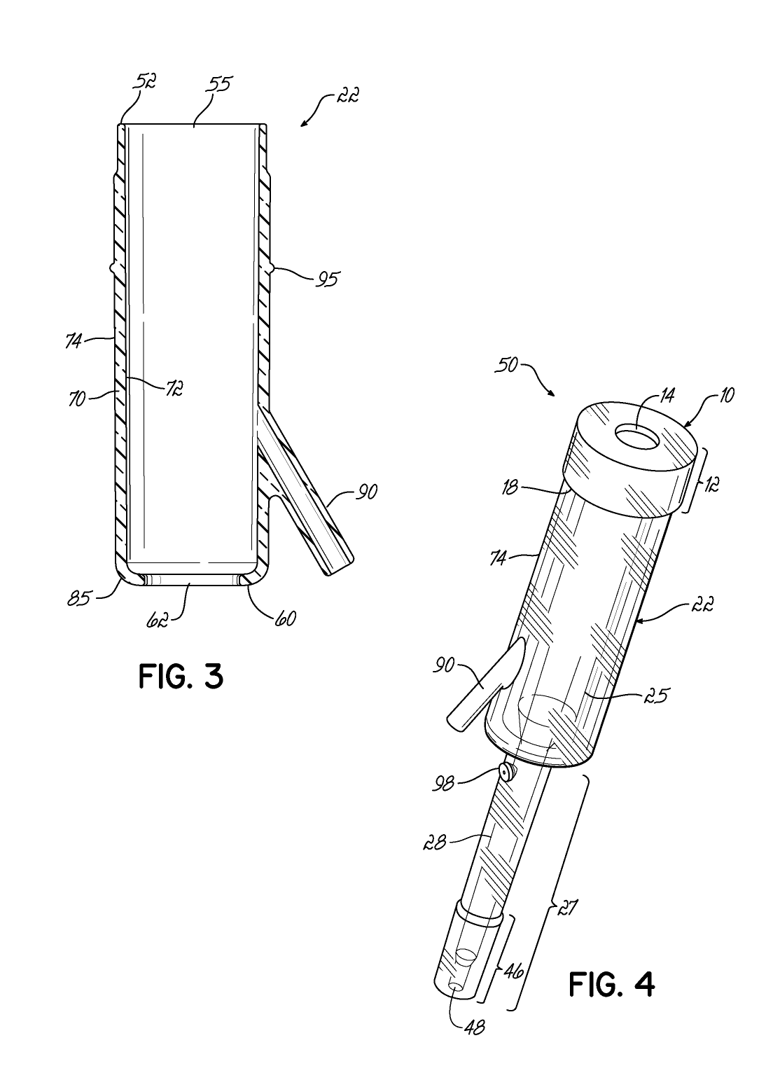

Referring to FIGS. 2 and 3, in use the dairy inflation 10 is received by a shell member 22 to form a milking device 50 that may be constructed from relatively non-flexible materials such as steel, polyvinyl chloride, polycarbonate, or other similarly non-flexible materials. In one embodiment, the shell member 22 is constructed from polycarbonate, such as food-grade polycarbonate PC-1029, which is commercially available from Network Polymers, Inc. (Akron, Ohio). Accordingly, a milking device comprising the shell member 22 constructed from a clear polycarbonate, in combination with the dairy inflation 10 constructed from a homogenous, clear polyurethane composition, provides an ability to visually monitor the massaging of the teat, as well as the milk extraction process itself.

The shell member 22 includes a proximal end 52 having a proximal opening 55 that is engaged with the mouth portion 12, and a distal end 60 having a distal opening 62 that is engaged with the reinforcement ring 35 that is present in the transition region 29 from the milk tube portion 27 to the flexible sleeve 24. The shell member 22 further includes a wall 70 connecting the proximal and distal openings 55, 62. The shell member 22 may be substantially cylindrical in form, although the cross-sectional shape of shell member 22 could be any shape. In one embodiment, the cross-sectional shape of the wall 70 is substantially identical to that of the exterior surface 43 of the flexible sleeve 24 of the dairy inflation 10. The interior surface 72 of the wall 70 of the shell member 22 and the exterior surface 43 of the flexible sleeve 24 define an annulus 80. The inner diameter of the shell member 22 is preferably uniform throughout the majority of the shell member 22, with the exception of an inwardly tapered portion 85 at the distal end 60 of the shell member 22. The diameter of the inwardly tapered portion 85 gradually decreases until reaching a minimum diameter associated with the distal opening 62. The shell member 22 further includes a vacuum tube 90 connected to the wall 70 to allow fluid communication with the annulus 80.

It is further contemplated that the exterior surface 74 of the wall 70 have one or more protrusions 95 extending outwardly. The protrusion(s) 95 may be formed in a circumferential ring extending around the shell member 22 or the protrusions may be individual rounded or blunt objects spaced apart around an imaginary circumferential line on the exterior surface 74. The protrusion(s) serve as physical stops for weighted rings (not shown) to be added to the milking device 50 to compensate for the lighter weight materials (e.g., polycarbonate and polyurethane), relative to the prior art devices (e.g., stainless steel and carbon black-filler natural rubber). Accordingly, these protrusions may be referred to as “weight stop protrusions.”

When engaged to the dairy inflation 10, the proximal end 52 of the shell member 22 may be received by the recess 20 and sealingly engages the lip 18 of the mouth portion 12. The distal end 60 may be received by the recess 39 and sealingly engages the umbrella 37 of the flexible sleeve 24. The reinforcement ring 35 prevents premature wear or tearing of the dairy inflation 10 caused by inwardly tapered portion 85 of the distal end 60 of the shell member 22. As illustrated in FIGS. 2 and 4, the lip 18 of the mouth portion 12 and the umbrella 37 of the flexible sleeve 24 are sized to provide an interference fit with the shell member 22. As the dairy inflation 10 is placed within the shell member 22, the lip 18 and the umbrella 37 may elastically deform to allow the ends of the shell member 22 to fit within each of the respective recesses 20, 39. This elastic deformation allows the dairy inflation 10 to more effectively seal each end of the shell member 22, as the dairy inflation 10 is stretched and locked into place.

The opening 14 of the mouth portion of 12 is placed over the teat of an animal to be milked. The mouth portion 12, like the other portions of the dairy inflation, is flexible, and a relatively tight seal is obtained around the teat of the animal. When the teat is fully engaged by the dairy inflation 10, the teat extends into the flexible sleeve 24 of the dairy inflation 10. In practice, several teats of an animal are milked together to increase milk production and reduce the level of physical stress to the animal. Each teat of the animal may carry a separate dairy inflation 10. The dairy inflations 10 are connected at the opposite end to a milk collection apparatus (not shown). The milk collection apparatus includes a claw having a male fitting that is inserted through the distal opening 48 of the milk tube portion 27. The male fitting extends into the axial passage 28 until the end of the male fitting is located beneath the thickened wall portion 46. The thickened wall portion 46 provides added resistance to tearing that could be caused by contact of the milk tube portion 27 with the end of the male fitting. A plurality of male fittings is typically provided, one for each dairy inflation 10.

As shown in FIG. 1, a vent passage 96 may be formed in the wall 41 of the milk tube portion. The vent passage 96 serves to enable air to flow into the axial passage 28, which facilitates the movement of milk away from the teat and toward the collection apparatus (not shown). The facilitated milk transfer away from the teat minimizes the entry of pathogen into the teat opening. As shown in FIG. 1, the vent passage 96 may be filled with an adjustable port 98, which can adjust the size of the available air passageway. The vent passage 96 may also stand alone through the clear polyurethane wall 41, as a tiny or minute hole between about 0.010 inch to about 0.035 inch in diameter. The clear wall 41 makes it uniquely visible, should the vent passage 96 become clogged and need clearing with an appropriately-sized needle, or other medium.

In accordance with embodiments of the present invention, the mouth portion 12, flexible sleeve 24, and milk tube portion 27 may each be constructed of a clear polyurethane composition having a hardness between 25 shore A and 50 shore D at room temperature 77° F. (25° C.). The clear polyurethane composition having a hardness value between 25 shore A and 50 shore D at 77° F. (25° C.) provides the dairy inflation 10 with the appropriate flexibility to permit its use during the winter months in cold temperature climates, but still provides the requisite durability (e.g., tear resistance and wear resistance) for use in a dairy parlor. Moreover, the clear polyurethane compositions described herein also provide many other unexpected benefits, as further described below.

In its most basic form, the clear polyurethane compositions useful for constructing the mouth portion 12, flexible sleeve 24, and/or milk tube portion 27 of the dairy inflation 10 are based on a combination of a reaction product of a polyol mixture comprising two or more polyols, e.g., a glycerine-based polyol and a glycol-based polyol, and a suitable cross-linking agent, e.g., a cross-linking agent comprising a plurality of isocyanate groups; and optionally other additives, e.g., a plasticizer. Accordingly, the polyurethane compositions used to form the dairy inflation 10 of the present invention can be formed by the reaction of two parts. Part A of the polyurethane composition includes the cross-linking agent. Part B of the polyurethane composition is a curative component that includes the polyol mixture, one or more catalysts, and optionally other additives such as a plasticizer and/or an antioxidant. In one embodiment, the polyurethane composition is void of any carbon black filler, which enables the desired clearness and transparency of the dairy inflation product. In accordance with another embodiment, the polyurethane composition is substantially free of any filler component. As used herein, “substantially-free of any filler component” means that less than 1 wt % of the total polyurethane composition contains any intentionally added fillers. Thus, in another embodiment, the polyurethane composition is void of any intentionally added filler component.

The clear and transparent (e.g., water clear or crystal clear) polyurethane composition provides for optimum viewing to see the milking process, whether the milk is flowing away from the teat properly and the inflation is massaging the teat correctly. Additionally, when no carbon or carbon black is used as a filler, these materials cannot shed into the milk stream, which often occurs with carbon black filled natural rubber, SBR, nitrile, or silicone, especially as the inflations age through use of milking and chemical and hot water washing. In accordance with an embodiment, an optical transparency of the cured polyurethane composition is about the same as or greater than the transparency value for float glass and/or the transparency value for ultra clear float glass (also known as low-iron glass), which are recognized standards in the glass field. For example, visible light transmittance of clear float glass is 88% or more; and visible light transmittance of ultra clear float glass is 91% or more. In another embodiment, the optical transparency of the cured polyurethane composition is equal to or greater than about 70%, as measure in accordance with ISO 13468-1:1996 (Plastics—Determination of the total luminous transmittance of transparent materials). For example, the optical transparency may be equal to or greater than about 75%, about 80%, about 85%, about 90%, or about 95%.

For example, in one embodiment, a dairy inflation made from a clear elastomer is provided that contains no carbon black, no plasticizers, no fillers, and no phthalates, and has a visible light transmittance of 70% or more. In another embodiment, a dairy inflation made from a clear elastomer is provided that contains no carbon black, no plasticizers, no fillers, and no phthalates, and has a clarity or transparency of clear float glass or better, with visible light transmittance of 88% or more. In yet another embodiment, a dairy inflation made from a clear elastomer is provided that contains no carbon black, no plasticizers, no fillers, and no phthalates, and has a clarity or transparency equivalent to ultra clear float glass (low iron glass), with visible light transmittance of 91% or more. In accordance with another embodiment of the present invention, the clear elastomer is a clear polyurethane elastomer.

The polyurethane composition of the present invention is chemically resistant to most cleaning agents and liquids used in the milking industry, and the composition is also non-absorbing, e.g., resistant to oil swell, milk absorption resistance, low permeation of water, milk, butter fat, and wash chemicals. The polyurethane compositions described herein also possess good tear and cut resistance, which is important for assembly to the sharp inserts at the claw, and as an indicator for general toughness against dairy parlor farm abuse. The polyurethane compositions are prone to less surface cracking or surface permeability, which in turn means less bacteria accumulation at the surface of the inflation device. The dairy inflations constructed of these polyurethane compositions may demonstrate increased durability and may be capable of 5,000 to 15,000 ICMs (individual cow milkings). In one embodiment, where the polyurethane composition does not contain any phthalate plasticizers, the added advantage of being phthalate-free is beneficial for less environmental and health concerns.

The stoichiometric relationship between Parts A (cross-linking agent) and B (curative component) may be based on a molar ratio of the isocyanate functional groups (NCO) in Part A to the hydroxyl functional groups (OH) in Part B. Accordingly, the cross-linking agent may be characterized by its isocyanate content, and the polyol compounds may be characterized by their respective hydroxyl numbers. According to embodiments of the present invention, the molar ratio of NCO:OH may be within the range of about 0.65:1.0 (or about 0.65) to about 1.0:1.05 (or about 1.05). For example, the NCO:OH molar ratio may be from about 0.65 to about 1.05, such as about 0.70, about 0.75, about 0.8, about 0.90, about 0.91, about 0.92, about 0.93, about 0.94, about 0.95, about 0.96, about 0.97, about 0.98, about 0.99, about 1.0, about 1.02, or about 1.05, or within a range between any combination of these ratios. However, the stoichiometry (i.e., ratio of NCO:OH) of a polymer system can affect the cured properties, such as leachables, tear resistance and wear resistance. Applicants have found that a polymer with NCO:OH molar ratio less than about 1 has improved tear resistance and wear resistance, which are important to the dairy inflation use in milking parlors, than a polymer with NCO:OH molar ratio of 1 or more. In one embodiment, a polyurethane composition is prepared using a NCO:OH molar ratio between about 0.90 and about 0.99. Thus, for improved durability, in one embodiment, it is advantageous to prepare the dairy inflation 10 from a polyurethane composition based on a NCO:OH molar ratio between about 0.93 to about 0.97.

In accordance with embodiments of the present invention, the cross-linking agent comprises a plurality of isocyanate groups. The cross-linking agent may include di- or multifunctional isocyanate compounds, or a quasi-prepolymer, which is a reaction product of one or more OH-terminated components, and one or more isocyanates.

Examples of suitable isocyanates include aromatic isocyanates such as 1,5-naphthylene diisocyanate, 2,4- or 4,4′-diphenylmethane diisocyanate (MDI), carbodiimide-modified MDI, xylylene diisocyanate (XDI), m- and p-tetramethylxylylene diisocyanate (TMXDI), the isomers of toluylene diisocyanate (TDI), 4,4′-diphenyl-dimethylmethane diisocyanate, di- and tetraalkyldiphenylmethane diisocyanate, 1,3-phenylene diisocyanate, 1,4-phenylene diisocyanate, 4,4′-dibenzyl diisocyanate; aliphatic isocyanates, such as hydrogenated MDI (H12MDI), 1-methyl-2,4-diiso-cyanatocyclohexane, 1,12-diisocyanatododecane, 1,6-diisocyanato-2,2,4-trimethyl-hexane, 1,6-diisocyanato-2,4,4-trimethylhexane, 1-isocyanatornethyl-3-isocyanato-1,5,5-trimethylcyclohexane (IPDI), tetramethoxybutane-1,4-diisocyanate, butane-1,4-diisocyanate, hexane-1,6-diisocyanate (HDI), dimeric fatty acid diisocyanate, dicyclo-hexylmethane diisocyanate, cyclohexane-1,4-diisocyanate, ethylene diisocyanate or phthalic acid bisisocyanato ethyl ester.

Low-molecular prepolymers may also be used, i.e., oligomers having a plurality of isocyanate groups, for example, the reaction products of MDI and/or TDI with low-molecular diols, e.g., ethylene glycol, diethylene glycol, propylene glycol, dipropylene glycol or triethylene glycol. These oligomers are obtained with an excess of monomeric polyisocyanate in the presence of diols. The molecular weight of the diols is generally less than 1,000 g/mol. The reaction product may optionally be freed of monomers by distillation. Crude MDI or liquefied diphenylmethane diisocyanates containing carbodiimide are likewise suitable. Suitable aliphatic isocyanates include isocyanurates, carbodiimides and biurets of isocyanates, in particular of HDI or IPDI. The mixture of polyisocyanates may be free-flowing at room temperature.

In one embodiment, the cross-linking agent comprises a diisocyanate compound. For example, the cross-linking agent may be selected from the group consisting of an aliphatic diisocyanate compound and a cycloaliphatic diisocyanate compound. In one example, the cross-linking agent is dicyclohexylmethane-4,4′-diisocyanate, which is commercially available under the tradename Vestanat® H₁₂MDI from Evonik Corporation (Parsippany, N.J.). The Vestanat® H₁₂MDI has a NCO content in a range from about 31.8 wt % to about 32.0 wt %. As described above, an amount of the cross-linking agent included in the polyurethane composition can be determined (or calculated) based on the sum total of the hydroxyl content for the polyol content in the mixture to achieve the desired NCO:OH molar ratio.

According to embodiments of the present invention, the polyol mixture comprises two or more polyols, which can include, but are not limited to, a glycerine-based polyol and a glycol-based polyol. One exemplary glycerine-based polyol may have an average molecular weight in a range from about 200 g/mol to about 300 g/mol and may be present in the polyurethane composition in an amount in a range from about 5 wt % to about 50 wt %, wherein wt % is based on the total weight of the polyol mixture. For example, this glycerine-based polyol may be present in the polyol mixture in about 5 wt %, about 10 wt %, about 15 wt %, about 20 wt %, about 25 wt %, about 30 wt %, about 35 wt %, about 40 wt %, about 45 wt %, or about 50 wt %, or within one or more ranges encompassed by combinations of any two of the foregoing. In one example, the glycerine-based polyol is Voranol® 230-660, which is a glycerine-propoxylated polyether polyol compound having an average molecular weight of about 250 g/mol, and has a hydroxyl number of about 675 (commercially available from Dow Plastics).

One exemplary glycol-based polyol may have an average molecular weight in a range from about 600 g/mol to about 700 g/mol and may be present in the polyol mixture in an amount in a range from about 20 wt % to about 90 wt %, wherein wt % is based on the total weight of the polyol mixture. For example, this glycol-based polyol may be present in the polyol mixture in about 20 wt %, about 30 wt %, about 40 wt %, about 50 wt %, about 60 wt %, about 70 wt %, about 80 wt %, or about 90 wt %, or within one or more ranges encompassed by combinations of any two of the foregoing. In one example, the glycol-based polyol is Terathane® 650, which is a polytetramethylene ether glycol compound having an average molecular weight in a range from about 625 g/mol to about 675 g/mol, and has a hydroxyl number in a range from about 179.5-166.2 (commercially available from Invista Corp, (Wilmington, N.C.))

In accordance with another embodiment, the polyol blend (or mixture of polyols) may further include a high molecular weight polyol. One exemplary high molecular weight polyol is a high molecular weight glycerine-based polyol having an average molecular weight in a range from about 4,000 g/mol to about 7,000 g/mol and may be present in the polyol mixture in an amount in a range from about 1 wt % to about 15 wt %, wherein wt % is based on the total weight of the polyol mixture. For example, this high molecular weight glycerine-based polyol may be present in the polyol mixture in about 1 wt %, about 3 wt %, about 5 wt %, about 7 wt %, about 9 wt %, about 10%, about 12 wt %, about 14 wt %, or about 15 wt %, or within one or more ranges encompassed by combinations of any two of the foregoing. In one example, the high molecular weight glycerine-based polyol is Voranol® 5815, which is a nominal 6,000 g/mol molecular weight capped polyether triol, and has a hydroxyl number of about 28.5 (commercially available from Dow Plastics).

Other non-limiting exemplary polyols suitable for inclusion into the polyol blend to make the clear polyurethane composition include Vorapel® hydrophobic polyols, such as Vorapel® T5001 and Vorapel® D3201; or medium (e.g., about 1,800 g/mol) molecular weight polyols such as Voranol® 223-060LM, both of which are commercially available from Dow Plastics).

While the hydroxyl groups and isocyanate groups can react in the absence of a catalyst, in order to accelerate the reaction and more fully cure the resulting polyurethane polymer, the reaction may be performed in the presence of a catalyst. In one example, the catalyst comprises dibutyltin dilaurate, which is commercially available under the tradename T12 (Dab, Corporation).

In accordance with embodiments of the present invention, the optional plasticizer content may be in a range from about 1 wt % to about 30 wt %, wherein the wt % of the plasticizer is based on the total weight of the polyurethane composition. When present, the plasticizer may be present in about 1 wt %, about 3 wt %, about 8 wt %, about 10 wt %, about 15 wt %, about 20 wt %, about 25 wt %, or about 30 wt %, or within one or more ranges encompassed by combinations of any two of the foregoing. The plasticizer may be an ester-type plasticizer selected from the group consisting of phthalate-based plasticizers, adipate-based plasticizers, sebacate-based plasticizers, maleate-based plasticizers, and benzoate-based plasticizers. In one example, the plasticizer comprises dipropylene glycol dibenzoate, which is commercially available under the tradename Benzoflex™ 9-88 from Eastman (Kingsport, Tenn.). In one embodiment, the amount of plasticizer added to the polyurethane composition may be varied to affect the desired shore hardness of the resulting cured polyurethane composition. In one example, the clear polyurethane composition comprises a sufficient quantity of plasticizer to provide a shore hardness between 25 shore A and 50 shore D at 77° F. (25° C.).

While described above as being formed from a single, integral piece of material, the dairy inflations 10 may be formed from multiple pieces of material that are joined either by connectors, adhesives, or other bonding or attachment methods.

According to another embodiment of the present invention, a method of making a dairy inflation for use in a vacuum-based milking device is provided. The method includes combining: about 5 wt % to about 50 wt % of a glycerine-based polyol having an average molecular weight in a range from about 200 g/mol to about 300 g/mol, and a first hydroxyl value; about 20 wt % to about 90 wt % of a glycol-based polyol having an average molecular weight in a range from about 600 g/mol to about 700 g/mol, and a second hydroxyl value; about 0.65 to about 1.05 stoichiometric equivalents of a cross-linking agent comprising a plurality of isocyanate groups; and optionally about 0 wt % to about 30 wt % of a plasticizer to form a polyurethane premixture. As described above, the stoichiometric equivalents of the isocyanate functional group of the cross-linking agent is based on a sum of the hydroxyl values of the polyols. The polyurethane premixture may further include additional polyols, a catalyst, and/or other conventional additives, such as UV stabilizers, antioxidants, etc. The method further includes filling a dairy inflation mold with the polyurethane premixture at between 100° F. to about 180° F.; and heating the filled dairy inflation mold to a temperature in a range from about 100° F. to about 500° F. for a sufficient duration to affect curing of the polyurethane premixture to form the dairy inflation comprising a clear polyurethane composition.

Optionally, the dairy inflation mold may be preheated to a temperature in a range from about 100° F. to about 200° F. prior to filling of the dairy inflation mold with the polyurethane premixture. Heating of the mold may continue during the filling process so as to maintain the desired temperature range or a desired temperature. However, to minimize heat transfer to the polyurethane premixture, the reactants may also be preheated. For example, a first mixture comprising the glycerine-based polyol and the glycol-based polyol may be formed and may be preheated at a temperature in a range from about 100° F. to about 180° F. Separately, the diisocyanate compound may also be preheated. As such, upon mixing metered portions of the preheated first mixture and the preheated diisocyanate compound prior to filling the dairy inflation mold, a preheated polyurethane premixture may be obtained.

The optional plasticizer and catalyst may be included in the first mixture or the second mixture. In one example, the plasticizer and the catalyst are components in the first mixture, along with the polyols.

Once the dairy inflation mold has been filled with the polyurethane premixture, the filled dairy inflation mold may be heated to a temperature in the range from about 200° F. to about 500° F. for a duration sufficient, e.g., for about an hour, so as to substantially cure the premixture. Once substantially cured, the dairy inflation comprising a clear polyurethane composition may be removed from the dairy inflation mold. Optional post-baking of the dairy inflation at a temperature in a range from about 200° F. to about 300° F. for a duration in a range from about 2 hours to about 4 hours can render the polyurethane fully-cured. Otherwise a full cure is generally achieved naturally within about seven days.

A method of milking a dairy animal includes inserting a teat into a milking device comprising the dairy inflation; and extracting milk from the teat by application of vacuum to an interior portion of the dairy inflation, and application of pulsating pressure on an exterior portion of the dairy inflation. Exemplary dairy animals include, cows, goats, sheep, and water buffalo.

### EXAMPLES

A dairy inflation in accordance with an embodiment of the present invention is produced using a 2-component cross-linking urethane material. It is dispensed as a low viscosity liquid, metered, and mixed by computer controlled precision gear motors. The materials, A & B, are stored in stainless steel tanks that are heated and kept under vacuum. The resins are metered, mixed, and pumped into open-topped, three-part molds. The molds are maintained at a temperature between 100° F. and 200° F. while the resin is poured therein and the molds filled. Then the molds are heated to 200° F. to 400° F. for one hour. The molds are removed from the heat source and taken apart and the finished liners are removed from the mold. Optionally, the liners are then post-baked at 200° F. to 300° F. for about 2 to about 4 hours.

Materials:

### Crosslinker (Part A)

| | |
|---|---|
| 00.65 to 1.05 | 100% Vestanat ® H-12 MID (Evonik Corp.) |
| equivalents (NCO:OH) | |

### Polymer Part (Part B)

| | | |
|---|---|---|
| 20-90 wt % | Terathane ® 650 | Invista Corporation |
| 5-50 wt % | Voranol ® 230-660 | DOW Chemical |
| 0-15 wt % | Voranol ® 5815 | DOW Chemical |
| 1-3 wt % | T12 | DAB Co. |
| 0-30 wt % | Benzoflex ® 9-88 | Eastman Chemical |

While the present invention has been illustrated by the description of one or more embodiments thereof, and while the embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, representative product and method and illustrative examples shown and described. Accordingly, departures may be made from such details without departing from the scope of the general inventive concept.

What is claimed is:

1. A dairy inflation for use in a vacuum-based milking device, comprising
a mouth having an opening configured to engage a teat of an animal,
a flexible sleeve connected to the mouth and including a first axial passage concentrically aligned with the opening in the mouth; and
a milk tube connected to the flexible sleeve and having a second axial passage concentrically aligned with the first axial passage of the flexible sleeve, wherein a reinforcing ring is present in a transition region from the milk tube to the flexible sleeve, and
wherein the flexible sleeve, and optionally the mouth and/or the milk tube, is formed of a clear polyurethane composition having a hardness between 25 shore A and 50 shore D at 77° F. (25° C.).

2. The dairy inflation of claim 1, further comprising
a shell member having a proximal end with a proximal opening engaged with the mouth of the dairy inflation, a distal end with a distal opening engaged with the milk tube of the dairy inflation, and a wall between the proximal and distal ends and connecting the proximal and distal openings thereby forming an annulus between the wall and the flexible sleeve, wherein at least a portion of the wall comprises a transparent material; and wherein an outer surface of the wall of the shell member optionally comprises a weight stop protrusion thereon.

3. The dairy inflation of claim 1, further comprising a vent passage in the milk tube.

4. The dairy inflation of claim 3, wherein the vent passage further comprises an exteriorly protruding port.

5. The dairy inflation of claim 1, wherein the clear polyurethane composition comprises:
a reaction product of
a polyol mixture comprising a glycerine-based polyol and a glycol-based polyol, and
a cross-linking agent comprising a plurality of isocyanate groups; and
an optional plasticizer.

6. The dairy inflation of claim 5, wherein the glycerine-based polyol has an average molecular weight in a range from about 200 g/mol to about 300 g/mol; and wherein the glycol-based polyol has an average molecular weight in a range from about 600 g/mol to about 700 g/mol.

7. The dairy inflation of claim 5, wherein the cross-linking agent comprising the plurality of isocyanate groups comprises a diisocyanate compound selected from a group consisting of an aliphatic diisocyanate compound and a cycloaliphatic diisocyanate compound.

8. The dairy inflation of claim 5, wherein the cross-linking agent comprising the plurality of isocyanate groups is dicyclohexylmethane-4,4′-diisocyanate.

9. The dairy inflation of claim 5, wherein the plasticizer is not optional; and wherein the plasticizer is an ester-type plasticizer selected from a group consisting of phthalate-based plasticizers, adipate-based plasticizers, sebacate-based plasticizers, maleate-based plasticizers, and benzoate-based plasticizers.

10. The dairy inflation of claim 9, wherein the plasticizer comprises dipropylene glycol dibenzoate.

11. The dairy inflation of claim 1, wherein the clear polyurethane composition comprises:
a reaction product obtained from:
a polyol mixture comprising
about 5 wt % to about 50 wt % of a glycerine-based polyol having an average molecular weight in a range from about 200 g/mol to about 300 g/mol, and a first hydroxyl value; and
about 20 wt % to about 90 wt % of a glycol-based polyol having an average molecular weight in a range from about 600 g/mol to about 700 g/mol, and a second hydroxyl value, wherein wt % is based on a total weight of the polyol mixture; and
about 0.65 to about 1.05 stoichiometric equivalents of a cross-linking agent comprising a plurality of isocyanate groups, wherein the stoichiometric equivalents is based on a sum of the first and second hydroxyl values; and
optionally about 0 wt % to about 30 wt % of a plasticizer, wherein wt % of the plasticizer is based on the total weight of the clear polyurethane composition.

12. The dairy inflation of claim 11, wherein the polyol mixture further comprises about 1 wt % to about 15 wt % of a high molecular weight glycerine-based polyol having an average molecular weight in a range from about 4,000 g/mol to about 7,000 g/mol, and a third hydroxyl value; and wherein the stoichiometric equivalents is based on a sum of the first, second, and third hydroxyl values.

13. The dairy inflation of claim 5, wherein the clear polyurethane composition is void of any carbon black filler.

14. The dairy inflation of claim 5, wherein the clear polyurethane composition is substantially void of any filler.

15. The dairy inflation of claim 5, wherein the composition further comprises a catalyst.

16. The dairy inflation of claim 15, wherein the catalyst comprises dibutyltin dilaurate.

17. A method of making a dairy inflation for use in a vacuum-based milking device, comprising
combining
a polyol mixture comprising:
about 5 wt % to about 50 wt % of a glycerine-based polyol having an average molecular weight in a range from about 200 g/mol to about 300 g/mol, and a first hydroxyl value, and about 20 wt % to about 90 wt % of a glycol-based polyol having an average molecular weight in a range from about 600 g/mol to about 700 g/mol, and a second hydroxyl value, wherein wt % is based on a total weight of the polyol mixture;
about 0.65 to about 1.05 stoichiometric equivalents of a cross-linking agent comprising a plurality of isocyanate groups, wherein the stoichiometric equivalents is based on a sum of the first and second hydroxyl values; and
optionally about 0 wt % to about 30 wt % of a plasticizer, to form a polyurethane premixture;
filling a dairy inflation mold with the polyurethane premixture; and
heating the filled dairy inflation mold to a temperature in a range from about 200° F. to about 400° F. to form the dairy inflation comprising a clear polyurethane composition.

18. The method of claim 17, wherein the dairy inflation mold is preheated to a temperature in a range from about 100° F. to about 200° F. and maintained in the temperature range during filling of the dairy inflation mold.

19. The method of claim 17, further comprising
preforming a first mixture comprising the glycerine-based polyol and the glycol-based polyol;
preheating the first mixture to a temperature in a range from about 100° F. to about 180° F.;
preheating the diisocyanate compound; and
mixing metered portions of the preheated first mixture and the preheated diisocyanate compound prior to filling the dairy inflation mold.

20. The method of claim 19, wherein the first mixture further comprises a catalyst.

21. The method of claim 20, wherein heating the filled dairy inflation mold to the temperature in the range from about 100° F. to about 400° F. is performed for about an hour.

22. The method of claim 17, further comprising:
removing the dairy inflation comprising the clear polyurethane composition from the dairy inflation mold; and
further heating the dairy inflation at a temperature in a range from about 200° F. to about 300° F. for about 2 hours to about 4 hours.

23. A method of milking a dairy animal, comprising
inserting the teat into a milking device comprising the dairy inflation of claim 1; and
extracting milk from the teat by application of vacuum to an interior portion of the dairy inflation and by application of pulsating pressure on an exterior portion of the dairy inflation.

24. A dairy inflation for use in a vacuum-based milking device, comprising a clear elastomer composition that contains no carbon black, no plasticizers, no fillers, and no phthalates, and has a visible light transmittance of 70% or more.

25. The dairy inflation of claim 24, wherein clear elastomer composition has a clarity or transparency of clear float glass or better, with visible light transmittance of 88% or more.

26. The dairy inflation of claim 24, wherein the clear elastomer composition has a clarity or transparency equivalent to ultra clear float glass (low iron glass), with visible light transmittance of 91% or more.

27. The dairy inflation of claim 24, wherein the clear elastomer composition comprises a clear polyurethane elastomer.
